(19) United States
(12) Patent Application Publication
(10) Pub. No.: US 2021/0343196 A1
(43) Pub. Date: Nov. 4, 2021

(54) Display Assembly

(71) Applicants: BEIJING BOE SPECIAL DISPLAY TECHNOLOGY CO., LTD., Beijing (CN); BOE TECHNOLOGY GROUP CO., LTD., Beijing (CN)

(72) Inventor: Chengbin WEI, Beijing (CN)

(21) Appl. No.: 16/323,328

(22) PCT Filed: Jun. 4, 2018
(86) PCT No.: PCT/CN2018/089780

§ 371 Date: Feb. 5, 2019

(30) Foreign Application Priority Data
Aug. 16, 2017 (CN) 201721022169.2

(51) Int. Cl. G09F 9/302; G09F 9/30; G09F 9/33

(52) U.S. Cl. CPC G09F 9/3026; G02F 1/13336; G09F 9/335; G09F 9/301

(57) ABSTRACT

The present disclosure provides a display assembly which includes a plurality of first displays provided with side walls spliced together, each of the first displays including a first display area and a first bezel surrounding the first display area, each first display area facing a display side, and a region between two adjacent first display areas being a splicing seam. The splicing seam on the display side is covered by a second display, and a type of the second display is different from that of the first displays.

### CROSS-REFERENCE TO RELATED APPLICATION

The present disclosure claims priority to Chinese Patent Application No. 201721022169.2 filed to State Intellectual Property Office of the Republic of China on Aug. 16, 2017, titled “Display Assembly”, the disclosure of which is hereby incorporated by reference in its entirety.

### TECHNICAL FIELD

The present disclosure relates to the field of splicing display technology, in particular, to a display assembly.

### BACKGROUND

In conference rooms, public places, command centers, etc., large-area displays (displays having an area much larger than that of conventional displays) are often used. The large-area displays are generally in the form of splicing displays. A spliced display device is formed by splicing a plurality of conventional displays, and an image to be displayed is split into several sub-images by an image splitter, then the several sub-images are transmitted to the plurality of conventional displays for display, respectively.

Currently, relatively practical conventional displays are mostly liquid crystal displays (LCDs), etc., and such a display inevitably has a bezel with a certain width in addition to a display area. Therefore, when the plurality of conventional displays are spliced together into one spliced display device, their bezels are placed closely adjacent to one another to form splicing seams. The splicing seams cannot be used for display, affect the picture quality, and reduce the viewer's comfort.

### SUMMARY

The present disclosure at least partially solves the problem that there are splicing seams in the prior splicing display device and the display quality is affected, and provides a display assembly which can avoid the influence of the splicing seams on the display quality.

The technical solution of the present disclosure for solving the above technical problem is a display assembly which includes a plurality of first displays provided with side walls spliced together, each of the plurality of first displays including a first display area and a first bezel surrounding the first display area, the first display area facing a display side, and a region between two adjacent first display areas being a splicing seam; the splicing seam on the display side is covered by a second displays, and a type of the second display is different from that of the first displays.

In some embodiments, the second display is a flexible display or a curved display, and includes a second display area and a second bezel surrounding the second display area; and the second bezel is bent towards the splicing seam with respect to the second display area.

In some embodiments, the second bezel is bent to be perpendicular to the second display area.

In some embodiments, the first display is a liquid crystal display.

In some embodiments, the second display is an organic light emitting diode display.

In some embodiments, the second display is a micro light emitting diode display.

In some embodiments, the second display is adhered to the first bezel.

In some embodiments, the display assembly further includes: a transparent outer frame provided at the plurality of first displays on the display side, the second display being adhered to the transparent outer frame.

In some embodiments, adjacent second displays are connected by bonding.

In some embodiments, all of the second displays cover all the splicing seams.

### BRIEF DESCRIPTION OF THE FIGURES

FIG. 1 is a structural diagram of first displays in a display assembly according to an embodiment of the present disclosure;

FIG. 2 is a structural diagram of second displays in a display assembly according to an embodiment of the present disclosure;

FIG. 3 is a structural diagram of a display assembly according to an embodiment of the present disclosure;

FIG. 4 is a structural diagram of a curved second display in a display assembly according to an embodiment of the present disclosure;

FIG. 5 is a structural diagram of a partial cross section of a splicing seam in a display assembly according to an embodiment of the present disclosure;

FIG. 6 is a structural diagram of a partial cross section of a splicing seam in another display assembly according to an embodiment of the present disclosure;

FIG. 7 is a structural diagram of a micro light emitting diode display in a display assembly according to an embodiment of the present disclosure; and

FIG. 8 is a structural diagram of a display assembly according to an embodiment of the present disclosure.

### DETAILED DESCRIPTION

The present disclosure will be further described below with reference to specific implementations and in conjunction with the drawings in order that those skilled in the art can understand technical solutions of the present disclosure better.

An embodiment of the present disclosure provides a display assembly which includes a plurality of first displays 1 with side walls thereof placed closely adjacent to one another and spliced together and second displays 2 with a different type from the first displays 1. The second displays 2 are provided at the positions for splicing the first displays 1 such that the display assembly achieves an overall seamless display.

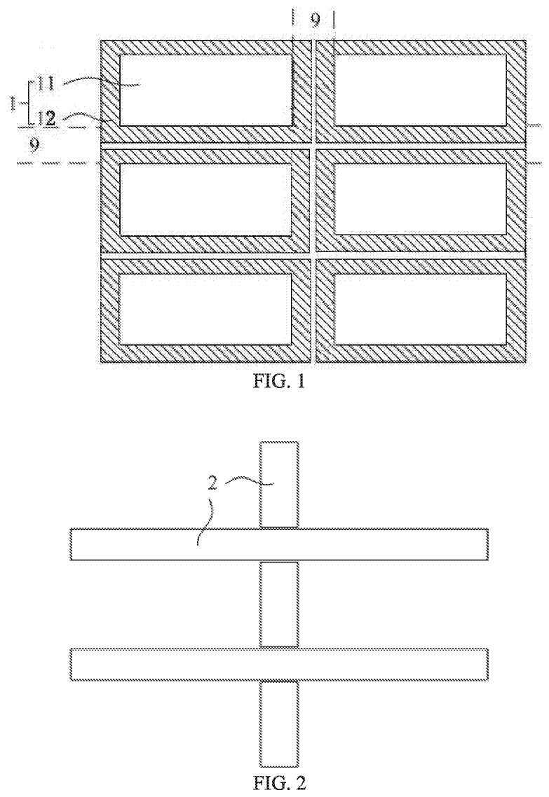

As shown in FIG. 1, each of the plurality of first displays 1, with side walls thereof placed closely adjacent to one another and spliced together, includes a first display area 11 and a first bezel 12 surrounding the first display area 11. Each of the first display areas 11 faces a display side of the display assembly, and splicing seams 9 without a display function with adjacent first bezels 12 may be formed between the first display areas 11 as the side walls of the plurality of first displays 1 are placed closely adjacent to one another and spliced together. It should be understood that while the first bezels 12 between the first display areas 11 are provided at the splice seams 9, other structures may be provided at the splice seams 9.

In order to achieve an overall seamless display of the display assembly, second displays 2 with a different type from the first displays 1 are provided at the splicing seams 9 on the display side so as to achieve displaying at the splicing seams 9. The number, size, shape, etc. of the second displays 2 may be determined according to the situation concerning the splicing seams 9. For example, as shown in FIG. 2, the second displays 2 each has a strip shape matching a respective splicing seam 9 in FIG. 1. The strip-shaped second displays 2 are provided according to the respective splicing seams 9 so that the second displays 2 are matched entirely with the splicing seams 9 after being spliced together.

It will be appreciated that, after the second displays 2 are provided, when splitting the image, sub-images to be displayed by the second displays 2, that is, sub-images corresponding to the positions of the splicing seams 9 (i.e., the positions of the second displays 2), should be also included. In this case, a sub-image of a first display 1 is continuous with sub-images of the adjacent second displays 2 instead of with sub-images of the adjacent first displays 1.

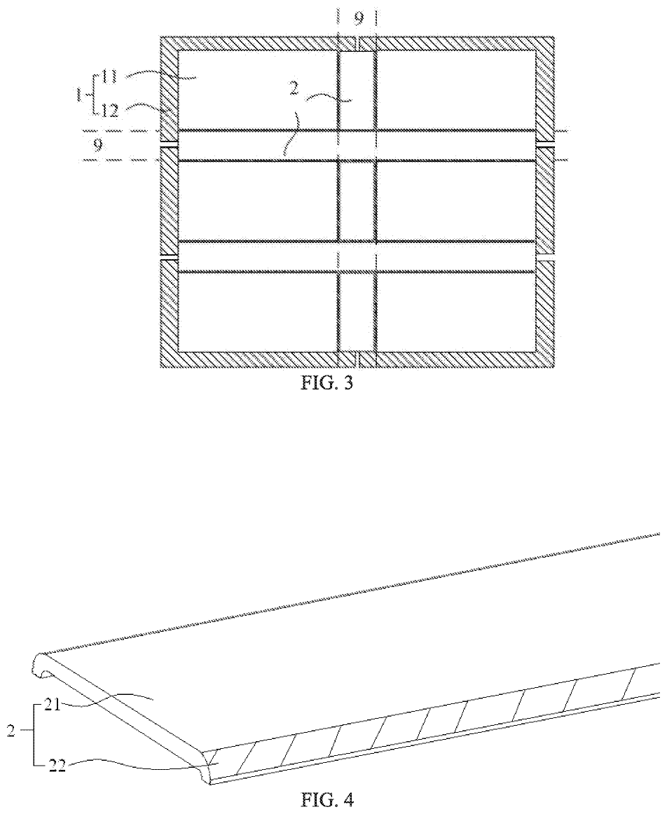

In the display assembly of the present embodiment, as shown in FIG. 3, the second displays 2 are provided at the splicing seams 9 to achieve displaying at the splicing seams 9, thereby enabling an overall seamless display of the display assembly. Thus the display quality is improved. Furthermore, the type of the second displays 2 is different from that of the first displays 1; for example, the first display 1 may be a display suitable for large area display (e.g., having a lower cost) while the second display 2 may be a display suitable for small area display (e.g., having a smaller bezel) so that the combination of the two types can exert their advantages, respectively.

In some embodiments, the second displays 2 cover all the splicing seams 9.

In some embodiments, in order to minimize the influence of the splicing seams 9 on the display effect, all the splicing seams 9 should be provided with the second displays 2. Moreover, it will be appreciated that only a part of the splicing seams 9 are provided with the second displays 2.

In some embodiments, as shown in FIG. 8, the first bezels at the outer edges of the display assembly may also be provided with the second displays thereon according to actual display requirements or process requirements.

In some embodiments, as shown in FIG. 4, the second display 2 is a flexible display which includes a second display area 21 and a second bezel 22 surrounding the second display area 21. The second bezel 22 is bent in a direction away from the display side with respect to the second display area 21. In some embodiments, the second bezel 22 is bent to be perpendicular to the second display area 21.

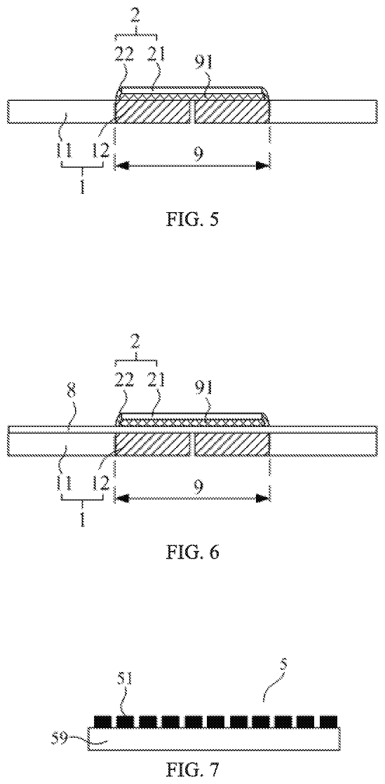

As shown in FIG. 5, in the case that the second display 2 is a flexible display or a curved display, its second bezel 22 is bent towards the splicing seam 9. In some embodiments, the second bezel 22 is bent to be perpendicular to the second display area 21. Generally, people view the display assembly at a position substantially facing towards the display area of the display. Therefore, in the case that the second bezel 22 is bent towards the splicing seam 9, the second bezel 22 is not visible or the second bezel 22 is very narrow, so that the area of the non-displayable area is further reduced, and an overall seamless display of the display assembly is achieved.

In some embodiments, the first displays 1 are liquid crystal displays.

The liquid crystal display (LCD) is one of the most commonly used display types at present, which has the advantages of low cost, high yield, and the like, so that it is easy to realize large area display, and is suitable for use as the first display 1.

In some embodiments, the second displays 2 are organic light emitting diode displays.

The organic light emitting diode (OLED) display is easy to achieve a flexible and curved display, and has a relatively small bezel size. However, since it has a high cost and a low yield, it is difficult for the OLED display to be used for large area display. Accordingly, the OLED display is just suitable for use as the second display 2 provided at the splicing seam 9 having a small size.

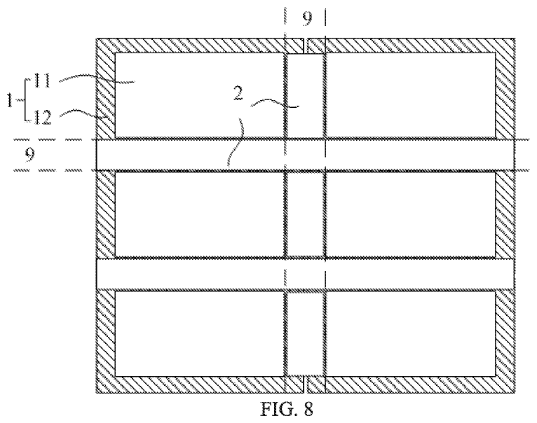

In some embodiments, the second displays 2 are micro light emitting diode displays 5. As shown in FIG. 7, the micro light emitting diode display 5 includes a substrate 59 and a plurality of micro light emitting diodes 51 provided on the substrate 59. The micro light emitting diode (Micro LED) 51 refers to a light emitting diode having a size of 1 to 10 μm level. A plurality of micro light emitting diodes 51 of various colors are disposed in an array on the substrate 59 (which may be rigid or flexible, and may be transparent or non-transparent), and are connected to controllable electrodes, respectively. Thus, by controlling signals of the respective electrodes by addressing, the brightness of each of the micro light emitting diodes 51 can be individually controlled, so that the plurality of the micro light emitting diodes 51 display a desired image as a whole. In some embodiments, each micro light emitting diode display 5 may also include structures such as a driving circuit, a protection layer, an encapsulation layer, and so on.

The micro light emitting diode displays 5 have advantages of simple structure, low cost, and so on. Although the display quality is relatively low, it is completely acceptable because they are used only for the splicing seams 9 which have a small area.

Moreover, it will be appreciated that the first displays 1 and the second displays 2 can be used for both 2D display and 3D display, can be used for both single-sided display and double-sided display, and can be used for both non-transparent display and transparent display, and so on. In the case of double-sided display, the display assembly has two display sides opposite to each other and each first display 1 has two first display areas opposite to each other each being surrounded by a respective first bezel, and thus the slicing seams 9 on the two display sides should be provided with the respective second displays 2,

In some embodiments, the second displays 2 are bonded on the first bezels 12. As shown in FIG. 5, the second display 2 may be bonded on the first bezel 12 directly by the adhesive 91 to cover the slicing seam 9.

In some embodiments, as shown in FIG. 6, the display assembly also includes a transparent outer frame 8 provided at the display side. The transparent outer frame 8 is, for example, a protective glass or a grating plate for realizing 31) display. The second display 2 is bonded on the outer frame 8.

In some embodiments, as shown in FIG. 2, adjacent second displays 2 may be bound together by the adhesive such as the optical clear adhesive, and thereby the second displays 2 are formed as a whole structure. Therefore, if the structure of the splicing seams 9 is complex and there are a large number of second displays 2, all the second displays 2 may be bound together as a whole structure first, and then the whole structure obtained by bonding is disposed at the splicing seams 9. Thus, the second display 2 is mounted in a more convenience manner, the cost is reduced, positioning is more accurate, and the display quality is improved.

Further, it will be appreciated that, the second displays 2 may be respectively disposed at (e.g., bonded to) the splicing seams of different positions after the first displays 1 are spliced together.

It will be appreciated that the above implementations are only exemplary implementations for illustrating the principle of the present disclosure. However, the present disclosure is not limited thereto. An ordinary person skilled in the art can make various modifications and improvements to the present disclosure without departing from the essence of the present disclosure. These modifications and improvements should be also considered as the protective scope of the present disclosure.

1. A display assembly, comprising:
a plurality of first displays provided with side walls spliced together, each of the plurality of first displays comprising a first display area and a first bezel surrounding the first display area, the first display area facing a display side, and a region between two adjacent first display areas being a splicing seam;
wherein,
the splicing seam on the display side is covered by a second display, and a type of the second display is different from that of the first displays.

2. The display assembly of claim 1, wherein,
the second display is a flexible display or a curved display, and comprises a second display area and a second bezel surrounding the second display area; and the second bezel is bent towards the splicing seam with respect to the second display area.

3. The display assembly of claim 2, wherein,
the second bezel is bent to be perpendicular to the second display area.

4. The display assembly of claim 1, wherein,
the first display is a liquid crystal display.

5. The display assembly of claim 1, wherein,
the second display is an organic light emitting diode display.

6. The display assembly of claim 1, wherein,
the second display is a micro light emitting diode display.

7. The display assembly of claim 1, wherein,
the second display is adhered to the first bezel.

8. The display assembly of claim 1, further comprising:
a transparent outer frame provided at the plurality of first displays on the display side, the second display being adhered to the transparent outer frame.

9. The display assembly of claim 1, wherein, two adjacent second displays are connected by bonding.

10. The display assembly of claim 1, wherein, all of the second displays cover all the splicing seams.

11. The display assembly of claim 2, wherein,
the first display is a liquid crystal display.

12. The display assembly of claim 3, wherein,
the first display is a liquid crystal display.

13. The display assembly of claim 2, wherein,
the second display is an organic light emitting diode display or a micro light emitting diode display.

14. The display assembly of claim 3, wherein,
the second display is an organic light emitting diode display or a micro light emitting diode display.

15. The display assembly of claim 4, wherein,
the second display is an organic light emitting diode display or a micro light emitting diode display.

16. The display assembly of claim 2, wherein,
the second display is adhered to the first bezel.

17. The display assembly of claim 3, wherein,
the second display is adhered to the first bezel.

18. The display assembly of claim 2, further comprising:
a transparent outer frame provided at the plurality of first displays on the display side, the second display being adhered to the transparent outer frame.

19. The display assembly of claim 3, further comprising:
a transparent outer frame provided at the plurality of first displays on the display side, the second display being adhered to the transparent outer frame.

20. The display assembly of claim 4, further comprising:
a transparent outer frame provided at the plurality of first displays on the display side, the second display being adhered to the transparent outer frame.
